(19) United States
(12) Patent Application Publication
(10) Pub. No.: US 2008/0253321 A1
(43) Pub. Date: Oct. 16, 2008

(54) AIR LINK BANDWIDTH ALLOCATION FOR VOICE OVER IP COMMUNICATIONS

(75) Inventors: Eamonn F. Gormley, Redmond, WA (US); Salai Sivakkani Thirunavukkarasu, Kirkland, WA (US)

Correspondence Address: HOLLAND & KNIGHT LLP, 10 ST. JAMES AVENUE, 11th Floor, BOSTON, MA, 02116-3889, US

(73) Assignee: SR Telecom Inc., Montreal (CA)

(21) Appl. No.: 11/965,417

(22) Filed: Dec. 27, 2007

Related U.S. Application Data
(60) Provisional application No. 60/877,343, filed on Dec. 27, 2006.

(51) Int. Cl. H04Q 7/20

(52) U.S. Cl. 370/329

(57) ABSTRACT

A system, method, and computer program product for receiving a Session Initiation Protocol (“SIP”) packet and analyzing at least a portion of the SIP packet to determine if the at least a portion of the SIP packet includes a request related to a bandwidth requirement. If the at least a portion of the SIP packet includes a request related to a bandwidth requirement, bandwidth of an air link for voice over IP (“VoIP”) communications over the air link is allocated based upon, at least in part, request related to a bandwidth requirement.

### CROSS REFERENCE TO RELATED APPLICATIONS

This application claims priority under 35 U.S.C § 119(e) to U.S. Provisional Application Ser. No. 60/877,340, entitled “Voice Over Internet Protocol (VOIP) Services Based on Snooping the SIP Protocol,” filed Dec. 27, 2006, the entire contents of which are hereby incorporated by reference.

### TECHNICAL FIELD

This disclosure generally relates to bandwidth management for air links, and more particularly relates to air link bandwidth management for voice over IP communications.

### BACKGROUND

An air link (e.g., a wireless communication channel) is the connection between a subscriber station and a base station. Air links have a finite amount of bandwidth that is available to transmit data to users of the air link. Typically, the bandwidth of an air link is apportioned among various users of the air link. For example, an air link designed to service one hundred simultaneous users may simply apportion one percent of the bandwidth of the air link to each of its one hundred users. However, certain users may have minimum bandwidth requirements. For example, a Voice-over-IP (i.e., VoIP) user may have higher bandwidth requirements and stricter latency requirements. Accordingly, if (as discussed above) the bandwidth of the air link is equally-distributed among one hundred users, the bandwidth apportioned to VoIP user may be insufficient and render the quality of the VoIP connection unacceptable.

In order to ensure that VoIP connections are maintained at an acceptable quality, typically a portion of the bandwidth of the air link may be reserved for VoIP connections. The quantity of the air link bandwidth reserved for VoIP connections may be based upon an estimate of how many VoIP connections may be taking place at any given time and the expected bandwidth required for each VoIP connection. The portion of the air link bandwidth reserved for VoIP connections is not used for other connections, e.g., general data connections, or other connections not having a minimum required bandwidth for acceptable service. Unfortunately, when fewer VoIP connections are in place than the estimate upon which the reserved bandwidth is based, the air link will be underutilized. The unused portion of the VoIP reserved bandwidth is not used for general data connections, or the like. This unused portion of bandwidth is a wasted resource.

### SUMMARY OF THE DISCLOSURE

According to a first implementation a method includes receiving a Session Initiation Protocol (“SIP”) packet. At least a portion of the SIP packet is analyzed and it is determined if the at least a portion of the SIP packet includes a request related to a bandwidth requirement. If the at least a portion of the SIP packet includes a request related to a bandwidth requirement, bandwidth of an air link is allocated for voice over IP (“VoIP”) communications over the air link based upon, at least in part, the request related to a bandwidth requirement.

One or more of the following features may be included. The SIP packet may include a request to set-up a new VoIP communication. If the bandwidth of the air link for VoIP communications is not fully utilized, allocating bandwidth may include allocating additional bandwidth of the air link for the new VoIP communication. If the bandwidth of the air link for VoIP communications is fully utilized, the request to set-up the new VoIP communication may be denied. The SIP packet may include a request for a new VoIP communication including an emergency call. If the bandwidth of the air link for VoIP communications is fully utilized, allocating bandwidth may include terminating one or more active VoIP communications to provide available bandwidth and allocating the available bandwidth for the new VoIP communication including the emergency call.

The SIP packet may include a request to terminate an existing VoIP communication, and allocating bandwidth may include decreasing allocated bandwidth of the air link for VoIP communications. Further, the SIP packet may include a request for a change in bandwidth requirements of an active VoIP communication. Allocating bandwidth may include allocating bandwidth of the air link based upon, at least in part, the request for the change in bandwidth requirements.

According to another implementation, a computer program product resides on a computer readable medium having a plurality of instructions stored on it. When executed by a processor, the instructions cause the processor to perform operations including receiving a Session Initiation Protocol (“SIP”) packet, and analyzing at least a portion of the SIP packet. It is determined if the at least a portion of the SIP packet includes a request related to a bandwidth requirement. If the at least a portion of the SIP packet includes a request related to a bandwidth requirement, bandwidth of an air link for voice over IP (“VoIP”) communications over the air link is allocated based upon, at least in part, the request related to a bandwidth requirement.

One or more of the following features may be included. The SIP packet may include a request to set-up a new VoIP communication. If the bandwidth of the air link for VoIP communications is not fully utilized, the instructions for allocating bandwidth may include instructions for allocating additional bandwidth of the air link for the new VoIP communication. If the bandwidth of the air link for VoIP communications is fully utilized, instructions may be included for denying the request to set-up the new VoIP communication. The SIP packet may include a request for a new VoIP communication including an emergency call. If the bandwidth of the air link for VoIP communications is fully utilized, the instructions for allocating bandwidth may include instructions for terminating one or more active VoIP communications to provide available bandwidth and allocating the available bandwidth for the new VoIP communication including the emergency call.

The SIP packet may include a request to terminate an existing VoIP communication. The instructions for allocating bandwidth may include instructions for decreasing allocated bandwidth of the air link for VoIP communications. The SIP packet may include a request for a change in bandwidth requirements of an active VoIP communication. The instructions for allocating bandwidth may include instructions for allocating bandwidth of the air link based upon, at least in part, the request for the change in bandwidth requirements.

According to a third implementation, a system includes a base station capable of establishing an air link with one or more subscriber stations. The air link is capable of supporting voice over IP (“VoIP) communications. The system further includes a Session Initiation Protocol (“SIP”) packet parser. The SIP packet parser is configured to receive a SIP packet and analyze at least a portion of the SIP packet. The SIP packet parser is configured to determine if the at least a portion of the SIP packet includes a request related to a bandwidth requirement. If the at least a portion of the SIP packet includes a request related to a bandwidth requirement, the SIP packet parser is configured to allocate bandwidth of an air link for VoIP communications over the air link based upon, at least in part, the request related to a bandwidth requirement.

One or more of the following features may be included. The SIP packet may include a request to set-up a new VoIP communication. If the bandwidth of the air link for VoIP communications is not fully utilized, the SIP packet parser may be configured to allocate additional bandwidth of the air link for the new VoIP communication. If the bandwidth of the air link for VoIP communications is fully utilized, the SIP packet parser may be configured to deny the request to set-up the new VoIP communication. The SIP packet may include a request for a new VoIP communication including an emergency call. If the bandwidth of the air link for VoIP communications is fully utilized, the SIP packet parser may be configured to terminate one or more active VoIP communications to provide available bandwidth and allocate the available bandwidth for the new VoIP communication including the emergency call.

The SIP packet may include a request to terminate an existing VoIP communication, and the SIP packet parser may be configured decrease allocated bandwidth of the air link for VoIP communications. The SIP packet may include a request for a change in bandwidth requirements of an active VoIP communication, and the SIP packet parser may be configured to allocate bandwidth of the air link based upon, at least in part, the request for the change in bandwidth requirements.

The details of one or more implementations are set forth in the accompanying drawings and description below. Other features and advantages will become apparent from the description, the drawings, and the claims.

### BRIEF DESCRIPTION OF THE DRAWINGS

FIG. 1 diagrammatically depicts a SIP packet parser coupled to a wireless data network.

FIG. 2 is a flowchart of a process executed by the SIP packet parser of FIG. 1.

### DETAILED DESCRIPTION OF PREFERRED EMBODIMENTS

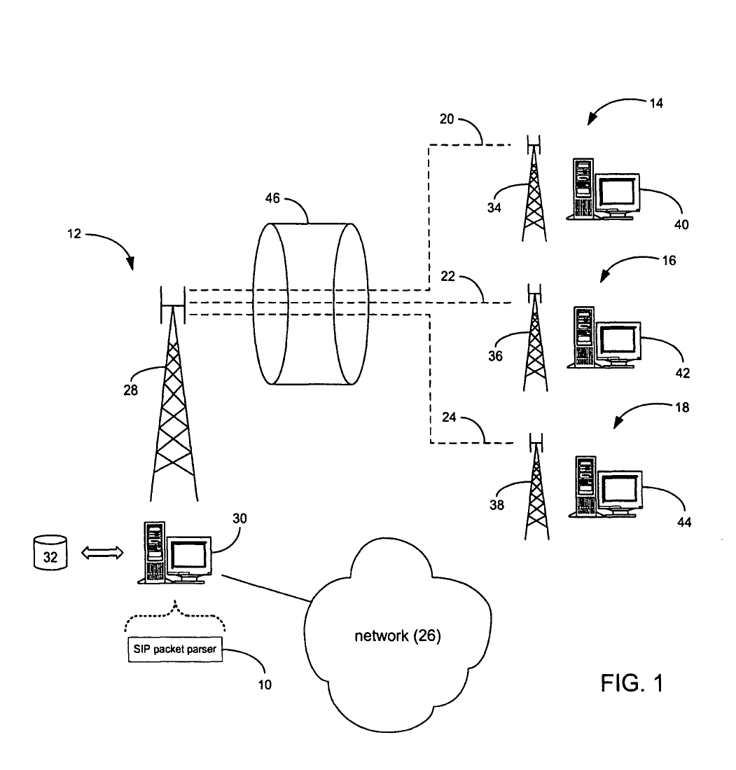

Referring to FIG. 1, there is shown Session Initiation Protocol (“SIP”) packet parser 10 for allocating air link bandwidth for VoIP communications, e.g., between base station 12 and one or more subscriber stations 14, 16, 18. Allocating air link bandwidth may include receiving a SIP packet. At least a portion of the SIP packet may be analyzed and it may be determined if the at least a portion of the SIP packet includes a request related to a bandwidth requirement. If the at least a portion of the SIP packet includes a request related to a bandwidth requirement, bandwidth of an air link may be allocated for voice over IP (“VoIP”) communications over the air link based upon, at least in part, the request related to a bandwidth requirement.

During operation, base station 12 may establish a plurality of wireless couplings 20, 22, 24 between base station 12 and the one or more subscriber stations 14, 16, 18 respectively. While three wireless couplings (i.e., 20, 22, 24) are shown in FIG. 1, this is for illustrative purposes only and is not intended to limit the scope of this disclosure. Various standards may govern and/or control the transmission of data across wireless couplings 20, 22, 24. One example of which may include, but is not limited to, IEEE 802.16, which may provide a wireless broadband system known as WiMAX.

Wireless couplings 20, 22, 24 may be bidirectional coupling that enable bidirectional communication between base station 12 and the one or more subscriber stations (e.g., subscriber stations 14, 16, 18). Base station 12 may be coupled to one or more distributed computing networks (e.g., network 26), examples of which may include but are not limited to the Internet, an intranet, a local area network, and a wide area network.

Base station 12 may generally include transceiver 28 (e.g., which may include one or more base radio units; not shown) and one or more computing devices 30 (e.g., which may include an application specific computing device, a personal computer, a server computer, a series of server computers, a mini computer, and a mainframe computer). The instruction sets and subroutines of SIP packet parser 10, which may be stored on a storage device (e.g., storage device 32) coupled to base station 12, are executed by one or more processors (not shown) and one or more memory architectures (not shown) incorporated into base station 12. Storage device 32 may, by way of example, include but is not limited to a hard disk drive, a tape drive, an optical drive, a RAID array, a random access memory (RAM), or a read-only memory (ROM).

The one or more subscriber stations (e.g., subscriber stations 14, 16, 18) may each include a transceiver (e.g., transceivers 34, 36, 38) capable of establishing wireless couplings 20, 22, 24 with transceiver 28 of base station 12. Subscriber stations 14, 16, 18 may also include one or more computing devices (e.g., computing devices 40, 42, 44) coupled to transceivers 34, 36, 38. Computing devices 40, 42, 44 may include, but are not limited to, an application specific computing device, a personal computer, a server computer, a series of server computers, a mini computer, and a mainframe computer, for example. One or more of subscriber stations 14, 16, 18 may be capable of establishing VoIP communications via wireless couplings 20, 22, 24.

The total bandwidth capacity 46 of the air link established by base station 12 may be apportioned among the one or more wireless couplings 20, 22, 24 (and, therefore, among the one or more computing devices 40, 44, 46). Each user/device need not be given an equal apportionment of the total bandwidth capacity of the air link. For example, certain users (e.g., VoIP users) may have minimum bandwidth requirements necessary to achieve an acceptable connection. The sum of the individual apportionments typically should not exceed the total bandwidth capacity 46 of e.g., the air link established by base station 12.

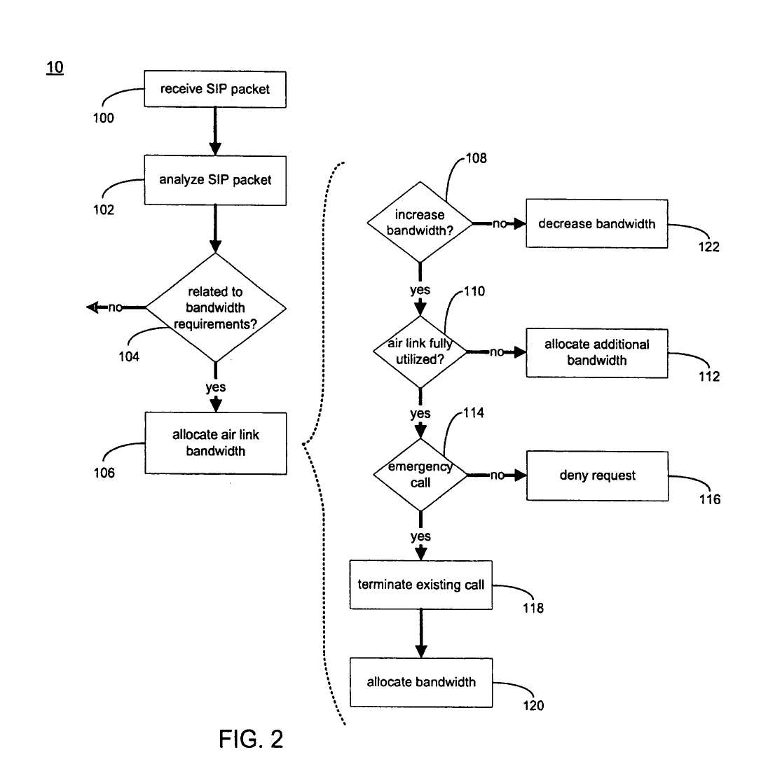

SIP packet parser 10 may allow bandwidth of an air link for VoIP communications to be allocated to provide sufficient bandwidth to achieve acceptable VoIP communications and may minimize and/or eliminate un-utilized portions of the air link bandwidth. Referring also to FIG. 2, SIP packet parser 10 may be configured to receive 100 a SIP packet and analyze 102 at least a portion of the SIP packet. SIP packet parser 10 may further determine 104 if the at least a portion of the SIP packet includes a request related to a bandwidth requirement. If the at least a portion of the SIP packet includes a request related to a bandwidth requirement, SIP packet parser 10 may allocate 106 bandwidth of an air link for VoIP communications over the air link based upon, at least in part, the request related to a bandwidth requirement.

As is known, SIP (e.g., which may be specified in RFC 3261 from the Internet Engineering Task Force SIP Working Group) is a request/response protocol for creating, modifying, and terminating sessions (e.g., VoIP communications) with one or more participants. SIP clients may use a transfer protocol (e.g., transfer control protocol (TCP) or user datagram protocol (UDP), for example) on a specified port (e.g., port 5060) to connect SIP servers (e.g., computing device 30) and SIP clients (e.g., computing devices 40, 42, 44), to relay SIP packets therebetween. While SIP packets may include information related to creating, modifying, and terminating sessions, the content (e.g., voice, video text, etc.) of the communications may be transferred over separate session protocols, e.g., real-time transfer protocol (RTP), for example, as specified in RFC 1889 from the Internet Engineering Task Force Audio-Video Transport Working Group. The bandwidth of the air link for VoIP communications may include the bandwidth for transferring the content of the communications over the session protocol. Control information for transfer of the content of the communication (e.g., RTP flow) may be provided on a separate channel (e.g., as a separate data flow) of the air link. The control information may be transferred using a protocol such as Real-time Transport Control Protocol (“RTCP), e.g., as defined in RFC 3550 from the Internet Engineering Task Force Audio-Video Transport Working Group. RTCP packets may include data relating, e.g., to quality of service being provided by the RTP flow, but generally does not transport any content data. Control data (provided via RTCP packets) for VoIP communications may be carried on a separate channel of the air link from the content of the VoIP communications. Further, control information for more than one VoIP communication may be multiplexed over a single channel of the air link.

Continuing with the above-stated example, SIP packet parser 10 may receive 100 SIP packets on the specified port (e.g., on port 5060) from subscriber station 14, and may analyze 102 the SIP packets received from subscriber station 14. Analyzing 102 the SIP packets may include parsing the fields of the SIP packet, including the start line (e.g., which may include a request command type), message header (e.g., which may include information about the caller and the callee), and message body (e.g., which may include information such as RTP port, audio/video encoding scheme, an the like). For example, SIP packet parser 10 may analyze 102 the start line and message body of a SIP packet received 100 by SIP packet parser 10. The start line may include an INVITE request, which may indicate a request to set-up a new VoIP communication. Additionally, SIP packet parser 10 may analyze 102 the message body of the received 100 SIP packet, which may indicate, e.g., an audio encoding scheme (codec) of the intended VoIP communication.

Based upon the information included within the SIP packet, SIP packet parser 10 may determine 104 if the SIP packet includes a request related to bandwidth requirements. Continuing with the above-stated example, the SIP packet received 100 from subscriber station 14 may be a request to set-up a new VoIP communication, e.g., requiring bandwidth to be allocated for the new VoIP communication. Bandwidth of the air link for the VoIP communication may be based upon, at least in part, attributes of the codec to be used for the VoIP communication. As the SIP packet includes a request relating to bandwidth requirements, SIP packet parser 10 may allocate 106 bandwidth of an air link (i.e., may allocate a portion of total bandwidth capacity 46) for the new VoIP communication over the air link based upon, at least in part, the SIP packet request related to a bandwidth requirement.

Continuing with the above-stated example, base station 12 may provide dynamic VoIP service, in which no band width is reserved for VoIP traffic to guarantee voice calls. For example, bandwidth of the air link for VoIP communications may be allocated (e.g., from total bandwidth capacity 46) during set-up of a VoIP call. Bandwidth of the air link not allocated to VoIP communications may be utilized for other traffic (e.g., general data traffic between base station 12 and one or more of subscriber stations 14, 16, 18).

Allocating 106 bandwidth of the air link for the VoIP communication may include determining 108 if the request includes a request to increase the bandwidth. Continuing with the above-stated example in which the SIP packet includes a request to set-up a new VoIP communication, SIP packet parser 10 may determine 108 that the request includes a request to allocate 106 additional air link bandwidth for VoIP communications. Accordingly, SIP packet parser 10 may further determine 110 if the bandwidth of the air link for VoIP communications is fully utilized. For example, while no portion of total bandwidth capacity 46 may be specifically reserved for VoIP communications, there may be a maximum bandwidth available for VoIP communications (e.g., to ensure that non-VoIP usage of the air link is not unduly compromised). Additionally/alternatively, the maximum bandwidth available for VoIP communications may be the total bandwidth capacity 46 of the air link.

If SIP packet parser 10 determines 110 that the air link is not fully utilized (i.e., there exists sufficient band width available for new VoIP communications), SIP packet parser 10 may allocate 112 additional bandwidth of the air link for VoIP communications to allow for the new VoIP communication. Allocating 112 additional bandwidth of the air link for VoIP communications may include allocating 112 additional bandwidth of the air link for VoIP communications according to the bandwidth necessary to support the new VoIP communication, e.g., based upon, at least in part, the audio codec indicated in the SIP packet.

In the event that the air link is fully utilized (e.g., there is insufficient available bandwidth for the new VoIP communication), SIP packet parser 10 may determine 114 if the requested new VoIP communication includes a request for an emergency call (e.g., a “911” call for emergency services, such as police, fire, or ambulance). SIP packet parser 10 may determine 114 if the received 100 SIP packet includes a request for an emergency call by analyzing the “TO URI” field of the message header of the SIP packet. SIP packet parser 10 may be capable of referencing the “TO URI” field of the message header against one or more pre-defined emergency contact numbers to determine if the requested new VoIP communication is an emergency call.

If SIP packet parser 10 determines 110 that the air link is fully utilized, and the SIP packet parser 10 determines 114 that the requested new VoIP communication does not include a request for an emergency call, SIP packet parser 10 may deny 116 the request for the new VoIP call. For example, SIP packet parser 10 may provide an indicator that the call cannot be completed at this time, e.g., in the form of an audible or visual indicator.

However, if SIP packet parser 10 determines 110 that the air link is fully utilized, but also determines 114 that the requested new VoIP communication does include a request for an emergency call, the call should be completed. To complete the emergency call, SIP packet parser 10 may terminate 118 one or more existing VoIP calls. Terminating 118 one or more existing VoIP calls may free-up bandwidth of the air link for VoIP communications, thereby providing the necessary available bandwidth for completing the emergency VoIP call. Once the necessary bandwidth for the emergency VoIP call is available, SIP packet parser 10 may allocate 120 the available bandwidth of the air link for VoIP calls to the emergency call, allowing the emergency call to be completed. In an embodiment in which the maximum bandwidth of the air link for VoIP communications is less than total air link bandwidth capacity 46, rather than terminating one or more existing VoIP calls to provide the necessary bandwidth for completing the emergency call, SIP packet parser 10 may temporarily increase the maximum bandwidth (as a proportion and defined quantity of total bandwidth capacity 46) of the air link for VoIP communications for the purpose of completing the emergency call, e.g., without interrupting any existing VoIP communications.

The SIP packet may include a request to terminate an existing VoIP communication. For example, rather than a request to set-up a new VoIP communication, the received 100 may be a request to terminate an existing VoIP communication. SIP packet parser 10 may analyze 102 the received 100 SIP packet and may determine 104 that the SIP packet includes a request related to bandwidth requirements, and may allocate 106 bandwidth of the air link for VoIP communications based upon, at least in part, the change in bandwidth requirements. Allocating 106 bandwidth of the air link for VoIP communications may include determining 108 that the received 100 SIP packet includes a request to terminate an existing VoIP communication, resulting in a decrease in the bandwidth of the air link for VoIP communications.

For example, the existing VoIP communication may utilize a defined bandwidth (e.g., based upon, at least in part, the audio codec utilized by the call). SIP packet parser 10 may determine 108 that terminating the existing VoIP call may result in a decrease in the necessary bandwidth of the air link for VoIP communications by the defined bandwidth (e.g., which is being utilized by the existing VoIP communication). SIP packet parser 10 may, upon terminating the existing VoIP communication, decrease 122 the bandwidth of the air link for VoIP communications. Decreasing 122 the bandwidth of the air link for VoIP communications may allow the defined bandwidth (e.g., which was previously being utilized for the existing VoIP communication) to be utilized for other VoIP communication, for general data transfer via the air link, and the like.

Further, the SIP packet may include a request for a change in bandwidth requirements of an active VoIP communication. For example, during the course of an active VoIP communication one or more of the parties of the active VoIP communication may be capable of sending a facsimile (“fax”) transmission via the active VoIP communication. Modulated fax information passed over the air link via the active VoIP communication may require a different codec to ensure acceptable transmission of the fax information. The different codec utilized for the fax transmission may require a different bandwidth (e.g., may require greater bandwidth) than voice transmission via the existing VoIP communication. SIP packet parser 10 may receive 100 the SIP packet requesting the change in bandwidth and may analyze 102 the SIP packet to determine 104 that the SIP packet includes a request related to bandwidth requirements (e.g., includes a change in codec attributes). SIP packet parser 10 may allocate 106 bandwidth of the air link for VoIP communications based upon, at least in part, the change in bandwidth requirements necessitated by the change in codec attributes.

Allocating 106 bandwidth may include determining 108 if the change in bandwidth requirements would result in an increase in the bandwidth of the air link for VoIP communications. If allocating 106 bandwidth would not result in an increase in bandwidth, SIP packet parser 10 may decrease 122 (or leave unaltered) the allocated bandwidth of the air link for VoIP communications. If SIP packet parser 10 determines 108 that the request is a request to increase the bandwidth of the air link for VoIP communications, SIP packet parser 10 may further determine 110 if the air link if fully utilized. If the air link is not fully utilized, SIP packet parser 10 may allocate 112 additional bandwidth of the air link for the existing VoIP communication.

As described above, if SIP packet parser 10 determines 110 that the air link is fully utilized, SIP packet parser 10 may further determine 114 if the request includes a request for an emergency call. If SIP packet parser determines 114 that the request does not include a request for an emergency call, SIP packet parser 10 may deny 116 the request. On the other hand, if SIP packet parser 10 determines 114 that the request includes a request for an emergency call, SIP packet parser 10 may terminate 118 one or more other existing calls and may allocate 120 bandwidth for the requested change in bandwidth requirements.

A number of implementations have been described. Nevertheless, it will be understood that various modifications may be made. Accordingly, other implementations are within the scope of the following claims.

What is claimed is:

1. A method comprising:
receiving a Session Initiation Protocol (“SIP”) packet;
analyzing at least a portion of the SIP packet;
determining if the at least a portion of the SIP packet includes a request related to a bandwidth requirement; and
if the at least a portion of the SIP packet includes a request related to a bandwidth requirement, allocating bandwidth of an air link for voice over IP (“VoIP”) communications over the air link based upon, at least in part, the request related to a bandwidth requirement.

2. The method of claim 1, wherein the SIP packet includes a request to set-up a new VoIP communication, and if the bandwidth of the air link for VoIP communications is not fully utilized, allocating bandwidth includes allocating additional bandwidth of the air link for the new VoIP communication.

3. The method of claim 1, wherein the SIP packet includes a request to set-up a new VoIP communication, and if the bandwidth of the air link for VoIP communications is fully utilized, denying the request to set-up the new VoIP communication.

4. The method of claim 1, wherein the SIP packet includes a request to terminate an existing VoIP communication, and allocating bandwidth includes decreasing allocated bandwidth of the air link for VoIP communications.

5. The method of claim 1, wherein the SIP packet includes a request for a new VoIP communication including an emergency call, and if the bandwidth of the air link for VoIP communications is fully utilized, allocating bandwidth includes terminating one or more active VoIP communications to provide available bandwidth and allocating the available bandwidth for the new VoIP communication including the emergency call.

6. The method of claim 1, wherein the SIP packet includes a request for a change in bandwidth requirements of an active VoIP communication, and allocating bandwidth includes allocating bandwidth of the air link based upon, at least in part, the request for the change in bandwidth requirements.

7. The method of claim 1, wherein the allocated bandwidth of the air link for VoIP communications includes bandwidth allocated for the content of the VoIP communications.

8. The method of claim 7, wherein control data for the VoIP communications is carried on a separate channel of the air link from the content of the VoIP communications

9. A computer program product residing on a computer readable medium having a plurality of instructions stored thereon, which, when executed by a processor cause the processor to perform operations comprising:
receiving a Session Initiation Protocol (“SIP”) packet;
analyzing at least a portion of the SIP packet;
determining if the at least a portion of the SIP packet includes a request related to a bandwidth requirement; and
if the at least a portion of the SIP packet includes a request related to a bandwidth requirement, allocating bandwidth of an air link for voice over IP (“VoIP”) communications over the air link based upon, at least in part, the request related to a bandwidth requirement.

10. The computer program product of claim 9, wherein the SIP packet includes a request to set-up a new VoIP communication, and if the bandwidth of the air link for VoIP communications is not fully utilized, the instructions for allocating bandwidth include instructions for allocating additional bandwidth of the air link for the new VoIP communication.

11. The computer program product of claim 9, wherein the SIP packet includes a request to set-up a new VoIP communication, and if the bandwidth of the air link for VoIP communications is fully utilized, further including instructions for denying the request to set-up the new VoIP communication.

12. The computer program product of claim 9, wherein the SIP packet includes a request to terminate an existing VoIP communication, and the instructions for allocating bandwidth include instructions for decreasing allocated bandwidth of the air link for VoIP communications.

13. The computer program product of claim 9, wherein the SIP packet includes a request for a new VoIP communication including an emergency call, and if the bandwidth of the air link for VoIP communications is fully utilized, the instructions for allocating bandwidth include instructions for terminating one or more active VoIP communications to provide available bandwidth and allocating the available bandwidth for the new VoIP communication including the emergency call.

14. The computer program product of claim 9, wherein the SIP packet includes a request for a change in bandwidth requirements of an active VoIP communication, and the instructions for allocating bandwidth include instructions for allocating bandwidth of the air link based upon, at least in part, the request for the change in bandwidth requirements.

15. The computer program product of claim 9, wherein the allocated bandwidth of the air link for VoIP communications includes bandwidth allocated for the content of the VoIP communications.

16. The computer program product of claim 15, wherein control data for the VoIP communications is carried on a separate channel of the air link from the content of the VoIP communications

17. A system comprising:
a base station capable of establishing an air link with one or more subscriber stations, the air link capable of supporting voice over IP (“VoIP) communications; and
a Session Initiation Protocol (“SIP”) packet parser configured to:
receive a SIP packet;
analyze at least a portion of the SIP packet;
determine if the at least a portion of the SIP packet includes a request related to a bandwidth requirement; and
if the at least a portion of the SIP packet includes a request related to a bandwidth requirement, allocate bandwidth of an air link for VoIP communications over the air link based upon, at least in part, the request related to a bandwidth requirement.

18. The system of claim 17, wherein the SIP packet includes a request to set-up a new VoIP communication, and if the bandwidth of the air link for VoIP communications is not fully utilized, the SIP packet parser is configured to allocate additional bandwidth of the air link for the new VoIP communication.

19. The system of claim 17, wherein the SIP packet includes a request to set-up a new VoIP communication, and if the bandwidth of the air link for VoIP communications is fully utilized, the SIP packet parser is configured to deny the request to set-up the new VoIP communication.

20. The system of claim 17, wherein the SIP packet includes a request to terminate an existing VoIP communication, and the SIP packet parser is configured decrease allocated bandwidth of the air link for VoIP communications.

21. The system of claim 17, wherein the SIP packet includes a request for a new VoIP communication including an emergency call, and if the bandwidth of the air link for VoIP communications is fully utilized, the SIP packet parser is configured to terminate one or more active VoIP communications to provide available bandwidth and allocate the available bandwidth for the new VoIP communication including the emergency call.

22. The system of claim 17, wherein the SIP packet includes a request for a change in bandwidth requirements of an active VoIP communication, and the SIP packet parser is configured to allocate bandwidth of the air link based upon, at least in part, the request for the change in bandwidth requirements.

23. The system of claim 17, wherein the allocated bandwidth of the air link for VoIP communications includes bandwidth allocated for the content of the VoIP communications.

24. The system of claim 23, wherein control data for the VoIP communications is carried on a separate channel of the air link from the content of the VoIP communications
